(19) United States
(12) Patent Application Publication
(10) Pub. No.: US 2026/0050507 A1
(43) Pub. Date: Feb. 19, 2026

(54) MULTI-MODAL ATTRIBUTION FOR JOB FAILURE IN A DISTRIBUTED SYSTEM

(71) Applicant: Nvidia Corporation, Santa Clara, CA (US)

(72) Inventors: Yoli Shavit, Kibbutz (IL); Hanan Shteingart, Herzliya (IL); Kathy Razmadze Hirsch, Ramat Gan (IL); Gilad Saban, Rehovot (IL); Eitan Zahavi, Zichron Yaakov (IL)

(21) Appl. No.: 18/977,730

(22) Filed: Dec. 11, 2024

Related U.S. Application Data
(60) Provisional application No. 63/683,058, filed on Aug. 14, 2024.

(51) Int. Cl. G06F 11/07

(52) U.S. Cl. CPC G06F 11/079; G06F 11/0709

(57) ABSTRACT

Approaches presented herein provide for attribution of fault for a failure of a computing job performed by a distributed set of resources. Different types of data can be analyzed for different modalities, such as text or time series data from compute, networking, and/or storage resources used to perform the computing job. This can include, for example, performing statistical analysis or anomaly detection to identify potentially responsible resources. A trained language model can analyze information and evidence for the potentially responsible resources, and can generate an attribution report identifying the resources that were likely responsible for the failure, along with an explanation and one or more recommended remediation actions.

### CROSS-REFERENCE TO RELATED APPLICATIONS

This application claims priority to U.S. Provisional Patent Application Ser. No. 63/683,058, filed Aug. 14, 2024, and entitled “Unsupervised Multi-Modal Attribution for Job Failure in a Distributed System,” Attorney Docket Number 1R2674.052501, which is hereby incorporated herein in its entirety and for all purposes.

### TECHNICAL FIELD

This disclosure relates to the performance of computing jobs using a set of resources, and in particular to identifying the source of a failure or other issue or event with respect to such a job.

### BACKGROUND

In distributed computing systems, the processing of a computing job may be performed at least partially in parallel using a number of different resources. For large processing jobs, the number of resources to be used may be quite high. A failure of any of these resources during processing can lead to a failure of the entire job, which for large jobs may result in the loss of weeks or even months of work. Attributing the failure of a job to a faulty device and identifying the underlying cause is critical for subsequent mitigation and efficient resource management. Existing methods typically rely on regular expressions and hand crafted rules for attribution and cause determination, which provide limited coverage for node attribution as they cannot generalize to new failures and abnormal phenomena. In addition, these approaches typically are often limited to data and insights from single sources and modalities. While more recent efforts have attempted different approaches, such as may use statistical measures, matching, and deep learning methods, these approaches do not provide direct means for failure attribution. In addition, the need for ground truth labels, which are typically expensive and hard to obtain, limits the use of supervised learning.

### BRIEF DESCRIPTION OF THE DRAWINGS

Various embodiments in accordance with the present disclosure will be described with reference to the drawings, in which:

FIG. 1 illustrates an example system to perform computing jobs with attribution capability, according to at least one embodiment;

FIG. 2A illustrates an approach to automatic attribution using data from multiple modalities, according to at least one embodiment;

FIG. 2B illustrates an example attribution matrix, according to at least one embodiment;

FIGS. 3A, 3B, and 3C illustrate example prompts and output from a language model of an attribution system, according to at least one embodiment;

FIG. 4 illustrates an example resource cluster that can be used to perform portions of a compute job, according to at least one embodiment;

FIGS. 5A, 5B, 5C, and 5D illustrate example processes for performing attribution in a distributed system, according to at least one embodiment;

FIG. 6 illustrates components of a distributed system that can be utilized to generate, decimate, provide, and reconstruct image content, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), systems for performing generative AI operations (e.g., using one or more language models), systems for performing light transport simulation, systems for performing collaborative content creation for 3D assets, systems implemented at least partially using cloud computing resources, and/or other types of systems.

Approaches in accordance with various illustrative embodiments provide for the determination of a cause for a job failure in a distributed system, including attribution of the failure to at least one device (or “node”) of the system. Prior approaches generally rely on regular expressions and hand-crafted rules, which are unable to generalize to new types of failures or abnormal phenomena, and do not integrate data and insights from multiple sources which also limits the accuracy of the determinations. In at least one embodiment, a job failure can be attributed to one or more root cause nodes, which can encompass various compute and networking devices, as may include processors, adaptors, switches, links, and the like. A job failure can function as a trigger, which can cause relevant data to be collected and reported. Multiple types of data (e.g., text/logs and/or telemetry/time series data) can be gathered from multiple sources (e.g., networking, compute, storage) and analyzed to perform node attribution. An efficient representation of input data and participating nodes is generated that is agnostic to data source and modality, which can capture the relative importance of each log message (based on statistical analysis) or detect abnormal node behavior. This can be performed using importance matrices and/or anomaly detection, among other such options. Suspected nodes (e.g., hosts or network interface cards) and supporting evidence from this node attribution can be provided as input to a large language model (LLM), along with or as part of an input prompt, and the LLM can output an attribution report that identifies the nodes believed to have led to the job failure, along with evidence from the data, an explanation of the decision, and potentially one or more suggested actions. The attribution report can be surfaced via a dashboard or otherwise used to address the cause of the job failure.

Variations of this and other such functionality can be used as well within the scope of the various embodiments as would be apparent to one of ordinary skill in the art in light of the teachings and suggestions contained herein.

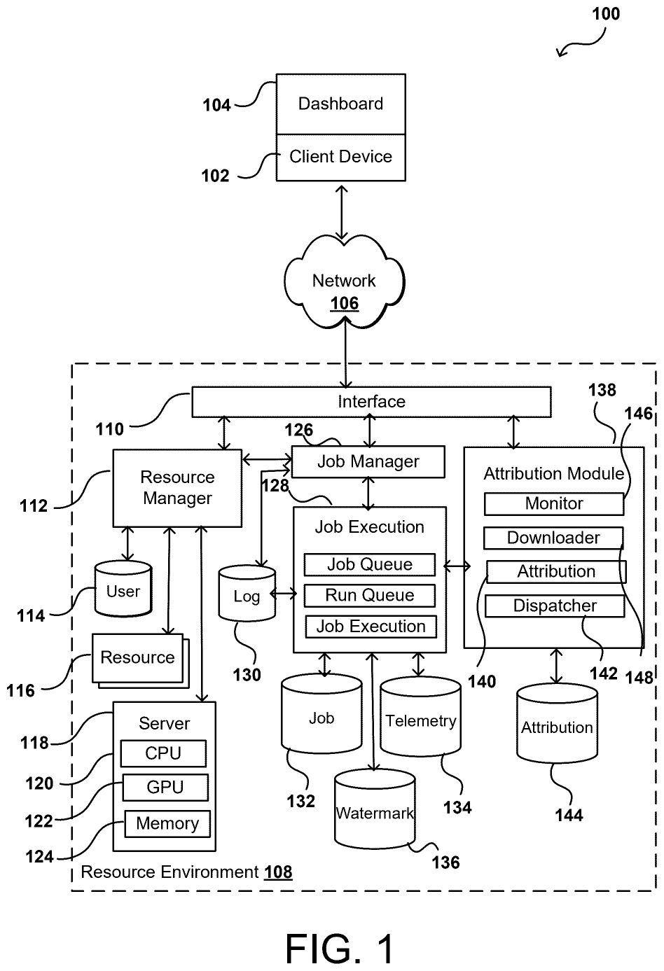

FIG. 1 illustrates an example distributed system 100 in which various jobs can be performed, according to at least one embodiment. In this example system 100, compute jobs (or other such operations or tasks) are able to be performed using a set of resources 116 of a resource environment 108, such as a cloud resource environment or shared resource environment offered by a resource provider. For example, a user might use a client device 102 to submit a request to perform a job across at least one network 106, such as a cellular network or the Internet, that can be received to an interface layer 110 of a resource environment 108. The interface layer 110, which may include components such as application programming interfaces (APIs), routers, load balancers, network switches, and the like, can direct the request to a job manager 126, for example, that can be tasked with managing such requests. The job manager 126 can work together with a resource manager 112 to determine the appropriate types of resources, and amount of resource capacity, to be allocated to perform the compute operation specified by the request. The resource manager 112 can check access and permissions for the user in a user data repository 114, for example, and can identify available resources (or resource capacity) from a pool of available resources 116. These resources can include various types of computing or electronic purposes used for any of a number of types of tasks, as may include compute resources, networking resources, or storage resources, among other such options. The resources can also include specific components on a given computing resource, such as a CPU 120, GPU 122, or portion of memory 124 on a given server 118. For large computing jobs, a resource manager 112 may allocate a number of resources of the same or different types, such as a number of GPUs on one or more servers to perform portions of the compute job in parallel.

In addition to ensuring availability and resources to perform a computing job, a job manager 126 can work with a job execution manager 128 in this example system 100 to manage execution of the job. Information for the job to be performed can be stored to a job queue, until such time as the resources are available to perform at least a portion of the job, at which time information for the job can be moved to a run queue. Data can be maintained in the run queue as different portions of the data may be pulled by different resources at different times during the course of performance. A job execution module can cause the appropriate information to be directed to the selected resources at the appropriate times, and can be responsible for receiving, aggregating, and processing the data to ensure job performance and produce an appropriate response to the request. In at least one embodiment, the job execution manager 128 can cause log messages for the performance to be written to a log repository 130 or other appropriate location. The log data can include information about the performance of a portion of the computing job by a given resource. Data and/or results for the job can be written to a job repository 132, with time series data for the performance being written to a telemetry repository 134 or other such location. Additional data for the performance, such as watermark data, may be written to a watermark repository 136 or other such location. The telemetry data can relate not only to the compute resources used in performance of the job, but also to storage (e.g., database instances) and networking (e.g., network interface cards or switches) used in the performance. When the job has completed, the job manager 126 can generate an appropriate response to be provided to the client device 102, such as for display through a job dashboard 104 or other such interface.

It may be the case, however, that a job may fail for any of a number of different reasons that may be associated with any of a number of different resources that were used to perform the job. In this example, an attribution module 138 can be used that includes a job monitor 146, although in other embodiments a separate job monitor may be used. The job monitor 146 can sample a table with job results, such as may indicate whether a given job completed successfully or failed, or another event occurred for which attribution should be determined. When a job is determined to have failed, the job monitor 146 can trigger data collection services, such as may include a downloader 148, to download data relating to the job, as may relate to log data from a log repository 130 or time-series data from a telemetry repository, among other such data. This may include message data, counter data, or other data related to performance of the job, as may be determined from different types of resources such as compute resources, networking resources, or storage resources, among other such options. Telemetry data can be collected based in part on the job details, considering the start and end time and the resources (or “nodes”) that participated in (or were associated with performance of at least a portion of) the job. The job details and the collected data and passed to an attribution determination module 140 which can perform the attribution and output information for the attributed nodes, or nodes which were determined to likely be at least partially to blame for the failure of the job. The output can include other information as well, such as may include instances of framing evidence and suggested explanations, as well as one or more recommended actions or remediations. The output can be collected in a delta table, for example, as well as being provided for viewing via a job dashboard 104 on the respective client device 102. An authorized entity can then review the report and take appropriate action, as may be based in part on the recommendations. This may include, for example, working with the resource manager 112 to remove or restart resources, among other such options. In some embodiments, at least some amount of automatic remediation may be taken, such as to prevent additional jobs from being allocated to a suspected node until such time as the state of the node may be investigated.

Such a system 100 can be used to process jobs of various sizes and complexities, which can occupy different subsets of resources for different periods of time. This can include very large jobs, such as may involve the distributed training of deep neural networks (DNNs). Models such as large language models (LLMs) can be particularly time- and resource-intensive to train. Such training can be performed using multiple dedicated processors optimized for matrix operations, including processors (or processing units) such as graphics processing units (GPUs), tensor processing units (TPUs), and specialized chips optimized for artificial intelligence-related operations, for example, by distributing the model weights and other relevant data over many processors to be performed in parallel. Such devices often can share memory when performing such tasks. Memory can be shared in at least one embodiment using communication technologies such as remote direct memory access (RDMA). When performing such a job using distributed resources, a failure or issue with any of those resources can result in failure of the entire job as discussed above, which can cause the entire job to have to be retried at significant time and cost. If the resource(s) that led to the job failure cannot be accurately identified, and appropriate remediations taken, then there is a significant chance that the job may fail again. Using a completely different set of resources may not be practical, and delays in troubleshooting the cause of the failure can lead to further expense as well as delay in providing the trained model for inferencing.

Accordingly, approaches in accordance with at least one embodiment can attempt to automatically analyze the cause of a failure (or other such issue) for a given job, including attributing the failure of a job to a potentially faulty device. As mentioned, a job such as a training task can fail due to a fault or other such issue in a single compute processor or network device, and identifying the underlying cause can be critical for subsequent mitigation and efficient resource management. A node attribution process can be used that can automatically attribute a job failure to at least one “root cause” resource, referred to herein as one or more “nodes”. A “node” in this context can encompass both compute and networking aspects, including, for example, a compute processor unit (for example, an NVIDIA DGX), a host channel adapter (HCA), and/or a switch connected to the compute processor unit, which may be referred to as a “leaf” node. Such an approach can include other types of nodes as well, as may include links, switches, routers, and the like.

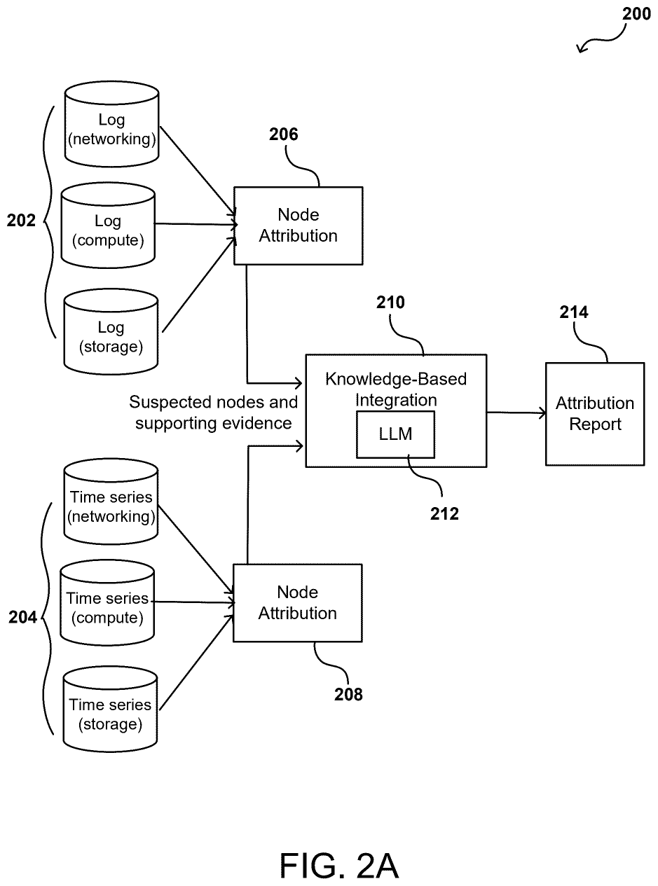

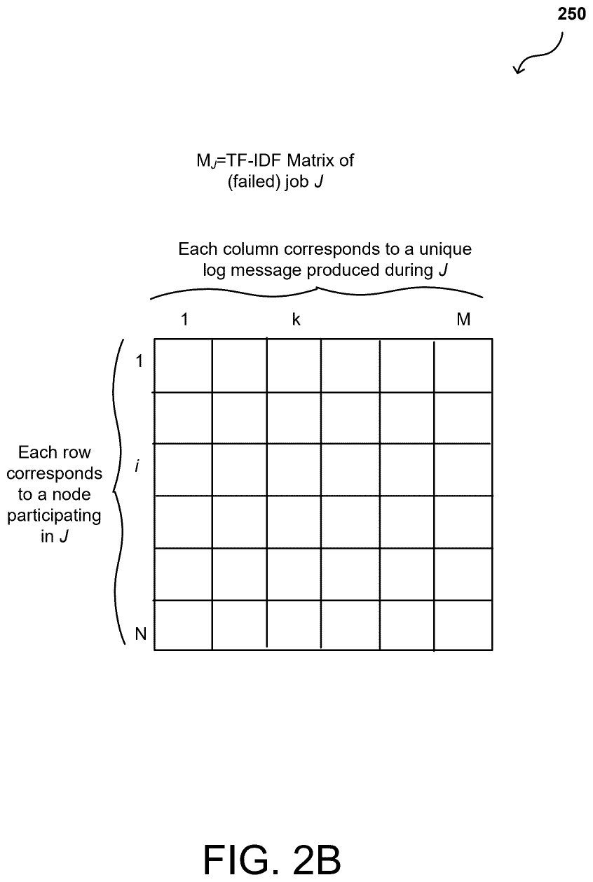

FIG. 2A illustrates an example attribution module 200 that can be used in accordance with at least one embodiment. An attribution module 200 can include one or more components and/or resources for performing attribution. In this example, an attribution module 200 can receive multiple types of input from multiple different sources. This may include, for example, log data 202 from various types of sources or modalities, such as sources related to networking, compute, and storage in a distributed system. This may also include, for example, time-series or telemetry data 204 from various types of sources or modalities, such as may also include sources related to networking, compute, and storage, among other such options. In one example, an attribution process can take these and/or other such instances of input data collected during the execution of a job or task that was determined to fail or experience another such issue. The attribution process, which can be an unsupervised process in at least one embodiment that does not require time-consuming and potentially complex labeling of data, can then output (as a list or in another appropriate format) identifying information for one or more nodes that were attributed to the failure. The output can include other information as well, such as evidence in support of the attribution, a suggested explanation for the failure and/or attribution determination, and one or more recommended actions.

In the example of FIG. 2A, an attribution module can include a set of primary components. A first such component is a first attribution module 206 that is able to identify resources (or nodes) that are potentially responsible for a job failure, based in part upon input log data (or other such data at least partially in text format). In at least one embodiment, this can include calculating importance matrices using term frequency-inverse document frequency (TF-IDF) values determined for various log messages, as discussed in more detail elsewhere herein. An example approach can construct an efficient representation for log messages and participating nodes that is agnostic to the data source and modality, where the representation can capture the relative importance of each log message and detect abnormal node behavior, such as node behavior that is statistically significant or varies from a statistically average or expected behavior. A second attribution module 208 can be used that is able to identify resources (or nodes) that are potentially responsible for a job failure, based in part upon input time series data (or other such data at least partially in a numerical format). In at least one embodiment, such attribution can be performed using time series anomaly detection, as discussed in more detail elsewhere herein. In one example, an approach used for log-based node attribution can be extended to time series data, allowing anomaly detection approaches to operate on a given matrix representation.

The output from the first and second node attribution modules 206, 208 can be a list of suspect nodes identified during the respective attribution processes, as well as supporting evidence. The evidence may include various types of evidence depending in part upon the respective source or modality, such as content of a respective log message. The output can be aggregated into a single set of suspect nodes (along with associated evidence or other such data), and the aggregated set can be provided as input to a knowledge-based integration module 210. Such a model can use one or more large language models (LLMs) 212 that can integrate knowledge and distill detection, as well as being able to suggest explanations and potential actions or mitigations, rather than simply summarizing and fetching semantically similar incidents. The knowledge-based integration module 210 can leverage the knowledge of LLMs to integrate and filter the evidence and associated data, such as the output provided from the various instances of these first and second node attribution modules 206, 208. A knowledge-based integration module can summarize relevant input, as well as filter out data (e.g., log messages) that are unlikely to be associated with a failure. This filtered and summarized data can then be used to generate one or more prompts to be provided as input to one or more LLMs 212. In this example, the output of the knowledge-based integration module 210 can be an attribution report 214 for a given job failure. The attribution report 214 can include, in text format, identifying information for one or more nodes determined to likely be the cause of, or at least associated with, the failure. The attribution report an also include any evidence determined to be relevant, such as information from log messages or time-series data, as well as an explanation for the attribution decision and one or more suggested actions or mitigations, among other such options.

FIG. 2B illustrates an example representation 250 that can be used for node attribution based on log-type data that can be used in accordance with at least one embodiment. As mentioned, a matrix representation can be used for a failed job (or other performed task or operation that had at least one identified issue, anomaly, irregularity, or other such problem). Given a job J and a stream of log messages collected during its execution, an importance matrix M_{J} can be constructed, where Mⱼ[i, k] is the term frequency-inverse document frequency (TF-IDF) value of a unique log message k with respect to the node i. A TF-IDF value is a statistical measure, originally developed for natural language processing tasks, which can be used to evaluate how relevant a word is to a document in a collection of documents. Such evaluation can be performed in at least one embodiment by multiplying the count of a word in each document with its inverse frequency across all documents. In the representation 250 of FIG. 2B, a unique log message can be considered as a word, and a node considered as a document.

A node attribution module can parse the relevant log data to identify unique log messages to be placed in the columns of the matrix, after any appropriate abstracting of information. A value such as the TF-IDF value can then be calculated for each entry in the matrix. In at least one embodiment, two such matrices can be created with a first matrix including data from an initial portion of the performance and a second matrix from a subsequent portion of the performance. This may include dividing the job performance by time-such as by taking the first 70% of performance for the first matrix and the final 30% for the second matrix. The first matrix can serve as a source of reference behavior, providing an additional criterion to use to identify abnormal behavior, which can be assumed to occur relatively close in time to the actual failure.

A log message k can be considered to be supporting evidence for attributing or “blaming” a node i with respect to the failure of a given job if its importance, as reflected by the TF-IDF values, exceeds the average importance of this log message across the population of nodes. In at least one embodiment, as a detection criterion, message (or “evidence”) k can be used to “blame” or attribute a node for a failure if:

$$blame\_score ( M [ i , k ] ) > s$$

$$where$$

$${blame}_{score ( v )} = \vert \frac{v - MEAN}{STD} \vert if v > 0 , else 0$$

In this example, Mⱼ[i, k] corresponds to the TF-IDF of message k with respect to job j, where each cell gives the TF-IDF value with respect to node i and message k. This provides a measure of the message frequency in each host versus the inverse frequency of the message across the hosts, which provides a measure of the importance of the respective message with respect to the host. An assumption can be made that abnormal faulty behavior will be indicated by log messages that carry significant importance to a small set of nodes. A log message j can be considered to be supporting evidence for blaming a node i if the TF-IDF value for that log message is larger than the average TF-IDF value for message j by a given margin, as may be defined based on the standard deviation as illustrated in FIG. 2B. The output of such a matrix operation can include suspect root cause nodes and the messages that provided evidence for that determination, among other such options. Such an approach can be extended to include temporal constraints that split the log corpus of the job over time, building two respective importance matrices. In such an example, at least one detection criterion can be extended to take into account the reference behavior during the initial phase of the job execution. Such an approach can assume that anomalous and important events are likely to occur close in time to the job failure.

For values or thresholds that are used for abnormal behavior determination can be user configurable. The score used for a matrix representation can be a hyperparameter that a user can set. Initial values may be more restrictive, but may be able to ease over time as LLMs provide more accurate inferencing and filtering, for example, allowing for a lower score threshold. An LLM can also use the score as part of its considerations, in addition to the provided evidence. The blame criteria itself can also be extended by users, and additional reference matrices can be used that may relate to jobs that have failed, or that were able to complete successfully. In at least one embodiment, the TF-IDF matrix can be normalized to a unit norm across nodes to eliminate the effect of the number of raw log messages and number of participating nodes. In such cases, the mean parameter can be set to 0.0, STD set to 1.0, and s set to a value close to 1, e.g. 0.8. Healthy messages can be learned from successful jobs and filtered out to increase precision, while erroneous messages can be collected over time from framing evidence and used to form rules to support attribution. This can be especially true for jobs with a relatively small number of nodes, where the statistical measure might be less effective. Reference statistics can be collected from successful jobs, as well as from earlier events of the failed jobs. Assuming temporal causality and a message classified as a framing evidence, one can record the just node with the earliest instance of the message rather than all nodes attributed by this message. Any or all of these or other such flags can be passed as arguments to the algorithm in a configuration.

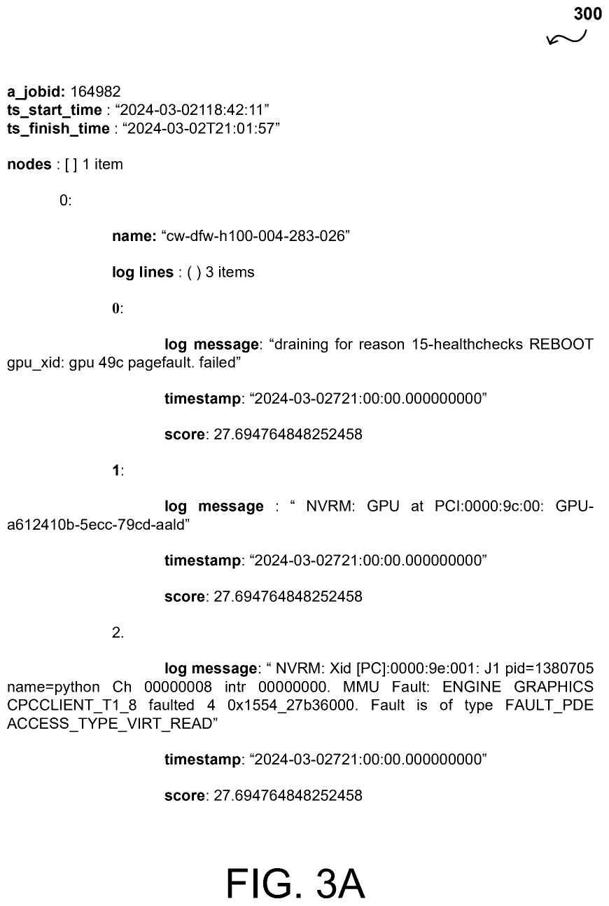

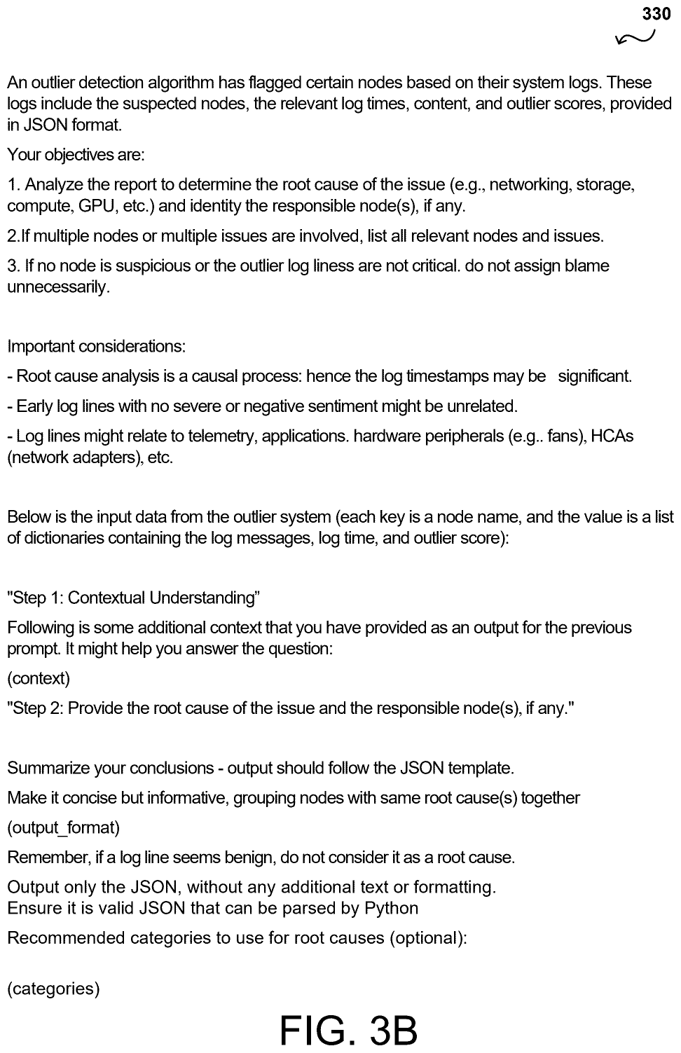

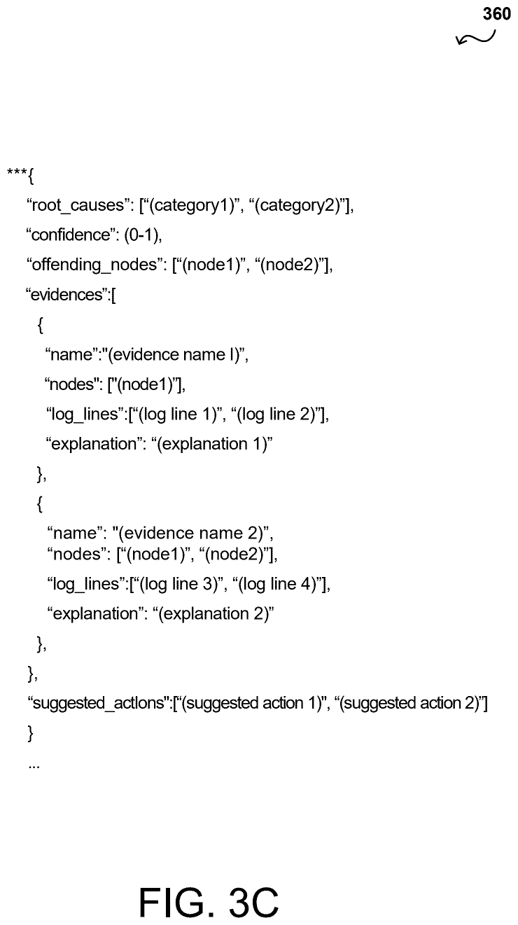

For each attributed node, the respective module can output a list of “framing” messages. Specifically, this module can output the latest raw message (corresponding to the framing unique message), as well as a timestamp for the latest raw message and its value in the importance matrix. FIG. 3A illustrates an example output document 300 for such node attribution with log data, according to at least one embodiment. Such an approach can be agnostic to the modality generating the log data, and can be applied to system logs, as well as logs collected from networking devices and other such messages or text files related to a given job. In addition, rules can be easily integrated into such a pipeline, as complementing rules or as may be used as a filter for the importance matrices-based analysis. The example output document 300 includes information such as the job identifier, as well as timestamps for when the job was started and when performance can completed or stopped. The output document can identify one or more nodes believed to be responsible for a failure, as well as the evidence (e.g., log lines) that led to the node being blamed for the failure. The document also includes a timestamp and an attribution score for a blamed node. The score can be generated using the respective TF-IDF values. As mentioned, a benefit to such an approach is that these determinations are made based on statistics and do not require any labeling of the data. Such an approach also allows for use of any relevant data from any appropriate and reliable source, allowing for extension of the types of data analyzed and the inclusion of additional protection criteria.

As mentioned, such a system can also perform node attribution with time series data (e.g., telemetry data) using time series anomaly detection. Similar to the approach used for importance matrices discussed above, a matrix can be constructed from a set of time series streams. A time series data stream (TSDS) can model timestamped metrics data as one or more time series, representing an efficient way to store metrics data. In an example importance matrix constructed from time series streams, the rows can correspond to nodes and the columns can correspond to time samples for a given counter. In at least one embodiment, such an approach can apply one or more anomaly detection methods. This can include, for example, using univariate and/or multivariate anomaly detection methods, among other such options. These anomaly detection methods can be used to attempt to detect anomalies per node, as well as anomalies across the population of nodes. Such an approach can then output data such as identifying information for a node, as well as the timestamp and the value of the “framing” counter.

If a failure in a compute job is detected, for example, this identifying information can be provided to an anomaly detection module to attempt to identify a subset of resources potentially associated with the failure using time series anomaly detection, which can attempt to identify outlier data points relative to a norm or expected range of values in the time series or telemetry data. Identifying information for the resources of an identified subsets (along with any other identified potentially responsible resources) can be provided as input to a trained language model. The information can be provided in a generated prompt, which can further include supporting evidence and other relevant information. An attribution report can be generated that indicates one or more resources inferred to be at least partially responsible for the failure of the computing job. The attribution report can contain other information as well, such as evidence for the attribution, an explanation for the attribution decision, and one or more suggested actions or remediations, among other such options.

In at least one embodiment, there may be multiple subsets, groups, or lists of nodes that are determined to be potentially responsible for a job failure, as may be determined using importance matrices, time series anomaly detection, or other such approaches. An aggregated list (or set of groups, etc.) of nodes suspected to be associated with a job failure can be generated, which can account for redundant entries or inconsistencies in identification, among other potential issues. Once generated, this aggregated list can be provided as input to a knowledge-based evidence integration module, or other such system, service or component. A knowledge-based evidence integration module may use, or include, one or more trained language models that are able to analyze the aggregated list, along with other supporting evidence, to attempt to attribute responsibility for a job failure to one or more nodes. The integration module can then generate an attribution report or otherwise provide information about the determined attribution. A pretrained model, such as an LLM, can be used to integrate and analyze various instances of supporting evidence. This evidence may include, for example, data such as timestamps, log messages, importance scores, and counter values, among other such options. The evidence in at least one embodiment can relate to events signified by specific counters, such as those associated with higher error rates, or anomalies detected for various nodes.

FIG. 3B illustrates an example prompt 330 that can be input to such an LLM in at least one embodiment. The prompt can include information such as the identification of one or more suspected nodes, important considerations, evidence data, and the like. The prompt can include language to ask the LLM to identify the root cause of the issue, as well as to identify one or more nodes inferred to be associated with the root cause or otherwise responsible for the issue. The LLM can then generate and output information (e.g., a final list) identifying one or more attributed nodes, as may be part of an attribution report. The attribution report can include information such as an explanation for the determination(s) of root cause and node attribution. The attribution report may also include one or more suggested actions to be performed to attempt to remedy the issue, which may impact the attributed nodes and/or other such components or devices.

FIG. 3C illustrates the format 360 of an example attribution report, according to at least one embodiment. The example output includes one or more identified root causes, as well as associated confidence scores and evidence. The output also includes one or more suggested actions. As mentioned, other types of components or resources can be considered nodes as well, with the same or similar methodology able to be used on logs, telemetry, and other such data collected from these components and used to generate additional suspected node indications as appropriate. In this example, there was a fault in an identified device, and the output can provide information about that device. The evidence may have been obtained from a system log at the level of compute, or from one or more network devices. Such an approach is not limited to specific locations from which the log or the time series data were obtained, and do not assume any prior knowledge but can analyze from a machine learning or statistical perspective, among other such options. Analysis of the content of individual log messages or other such data is not required, although could be used in some embodiments to attempt to help more accurately and quickly identify a reason for a given failure. Other types of information could be used as well, such as topologies, graphs, and the like.

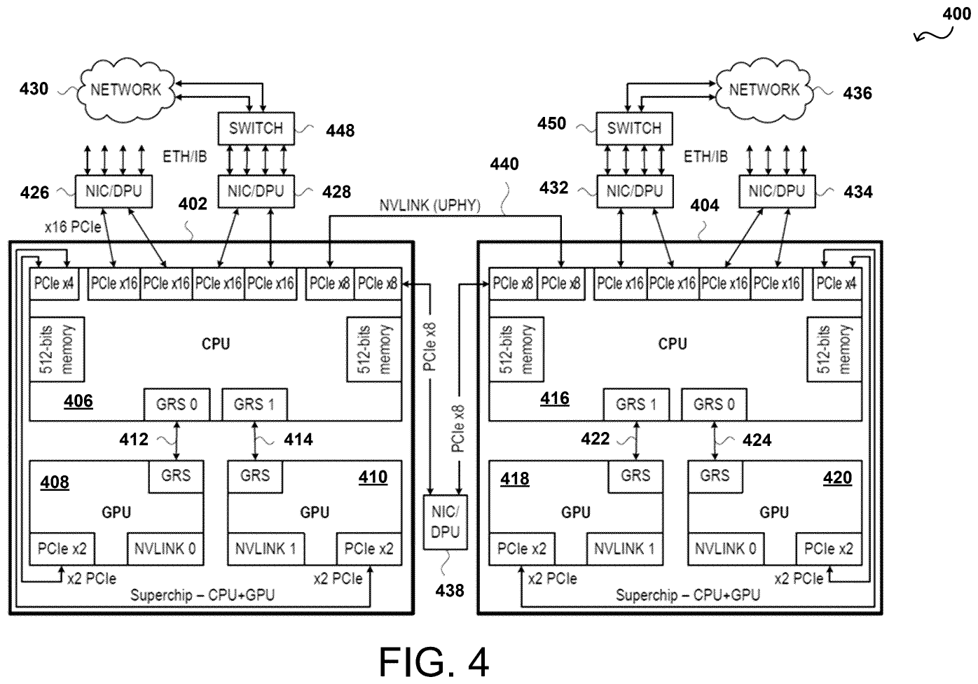

FIG. 4 is a block diagram that schematically illustrates a computing system 400, e.g., a data center or a High-Performance Computing (HPC) cluster, in accordance with an embodiment that is described herein. Such a computing system 400 can include a number of distributed nodes that can be used to perform portions of a computing job, where it can be desirable to identify nodes that may be responsible for a failure or issue with execution of that job. This example computing system 400 comprises a plurality of subsystems, e.g. multiple processing devices coupled to each other, multiple network devices, and multiple networks, according to at least one embodiment. This computing system 400 is designed with multiple integrated circuits (referred to as processing devices), where each integrated circuit can include one or more CPUs and GPUs, forming a powerful and flexible architecture. The various processing devices are interconnected, such as via an NVLink (from NVIDIA Corporation) or other high-speed interconnect, enabling high-speed communication between the subsystems, and are also connected through a network interface card (NIC) or data processing unit (DPU) to ensure efficient data transfer across the computing system 400 and to one or more external networks 430, 436. In the present example, the computing system 400 comprises a packet switch 448 that connects a second NIC/DPU 428 to a network 430, and a packet switch 450 that connects the first NIC/DPU 432 to another network 436. The coupling of processing devices (e.g., via NVLink) allows for seamless data exchange and parallel processing, enhancing overall computational performance. The processing devices can be connected to multiple networks through one or more NICs or DPUs, enabling the system to handle complex, multi-network tasks with high bandwidth and low latency. Such a configuration can be highly suitable for demanding applications that require significant processing power, such as artificial intelligence (AI), machine learning (ML), and data-intensive computing, while ensuring robust connectivity and scalability across various networked environments. The integrated circuits of this example computing system 400 can include one or more CPUs and one or more GPUs.

FIG. 4 also illustrates an example multi-GPU architecture. As illustrated, the example computing system 400 includes a processing device 402 with a multi-GPU architecture. In particular, the processing device 402 may be a system-on-chip and includes multiple subsystems such as a CPU 406, a GPU 408, and another GPU 410. The CPU 406 can be coupled to a GPU 408 via a die-to-die (D2D) or chip-to-chip (C2C) interconnect 412, such as a Ground-Referenced Signaling interconnect (GRS interconnect). The CPU 406 can also be coupled to another GPU 410 via a D2D or C2C interconnect 414. The CPU 406 can also couple to either GPU 408 and/or GPU 410 via one or more PCIe interconnects.

The CPU 406 can be coupled to one or more NICs or DPUs, which are coupled to one or more networks. For example, as illustrated in FIG. 4, a CPU 406 is coupled to a first NIC/DPU 426, which is coupled to a network 430. The CPU 406 is also coupled to a second NIC/DPU 428, which is coupled to a network 430 via a packet switch 448. The first and second NICs/DPUs 426, 428 can be coupled to a network 4030 over Ethernet (ETH), NVLINK or InfiniBand (IB) connections, for example.

This example computing system 400 also includes a processing device 404 with a multi-GPU architecture. In particular, the processing device 404 includes multiple subsystems including a CPU 416, a first GPU 418, and a second GPU 420. The CPU 416 can be coupled to the first GPU 418 via a D2D or C2C interconnect 422. The CPU 416 can also be coupled to a second GPU 420 via a D2D or C2C interconnect 424. The CPU 416 can also couple to the GPUs 418, 420 via PCIe interconnects. The CPU 416 can be coupled to one or more NICs or DPUs, which are coupled to one or more networks. For example, as illustrated in FIG. 4, the CPU 416 is coupled to a first NIC/DPU 432, which is coupled to a network 436. The CPU 416 is also coupled to a second NIC/DPU 434, which is coupled to a network 436 via a packet switch 450. The first and second NICs/DPUs 432, 434 can be coupled to a network 436 over Ethernet (ETH), NVLINK or InfiniBand (IB) connections.

In at least one embodiment, processing devices 402, 404 can communicate with each other via a NIC/DPU 438, such as over PCIe interconnects. The processing devices 402, 404 can also communicate with each other over a high-bandwidth communication interconnects 440, such as an NVLink interconnect or other high-speed interconnects. The packet switches in FIG. 4 may comprise, for example, Nvidia Quantum-2 switches. The NICs/DPUs in the figure may comprise, for example, Nvidia Bluefield DPUs.

Various components in such an example computing system 400 can represent, or be associated with, a node that is identified as a cause (or potential cause) of a job failure. This may include, for example, any of the processing devices 402, 404, CPUs 406, 416, or GPUs 408, 410, 418, 420. Nodes may also include, or comprise, one or more network devices of the example computing system 400, as may include any of first and second NICs/DPUs 426, 428, 432, 434, and 438, and/or any of the packet switches 448, 450, PCIe links, NVLINK communications links, and the like.

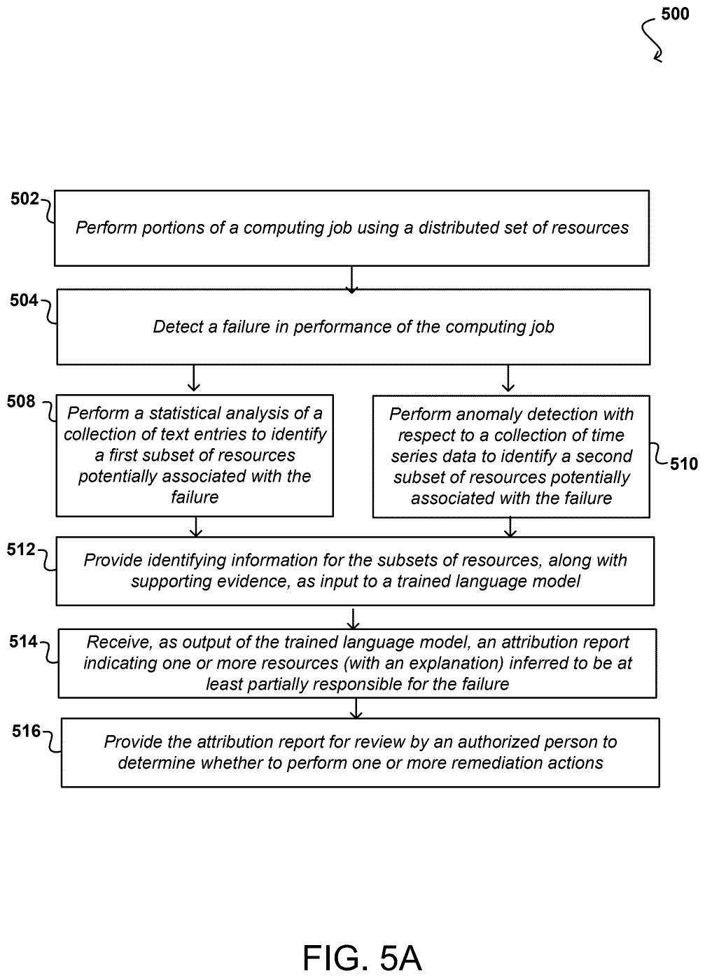

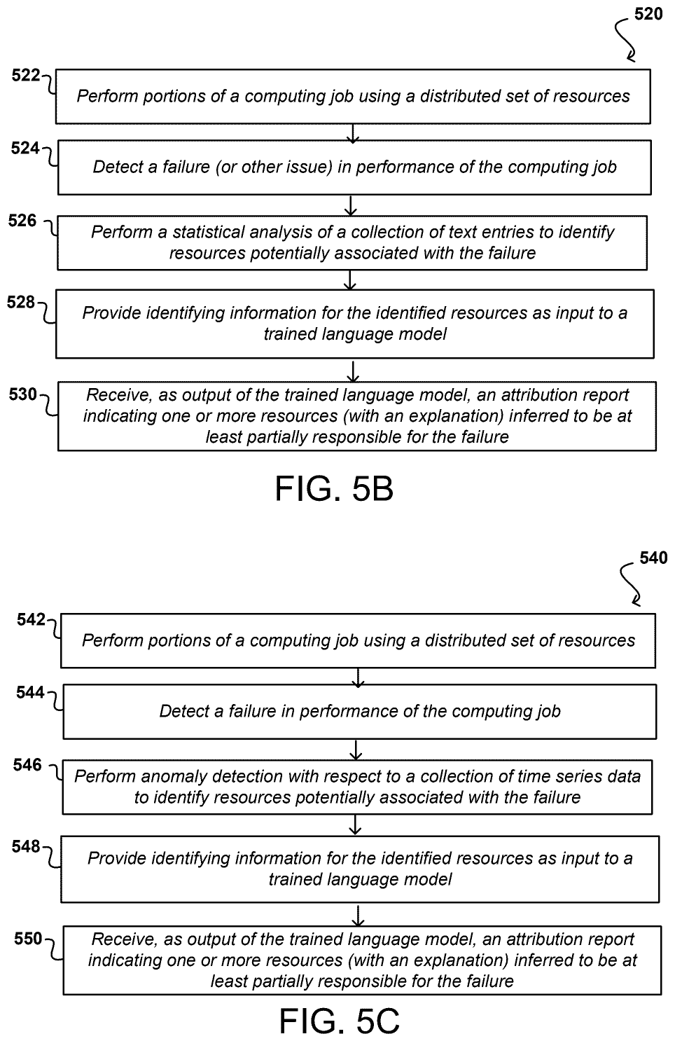

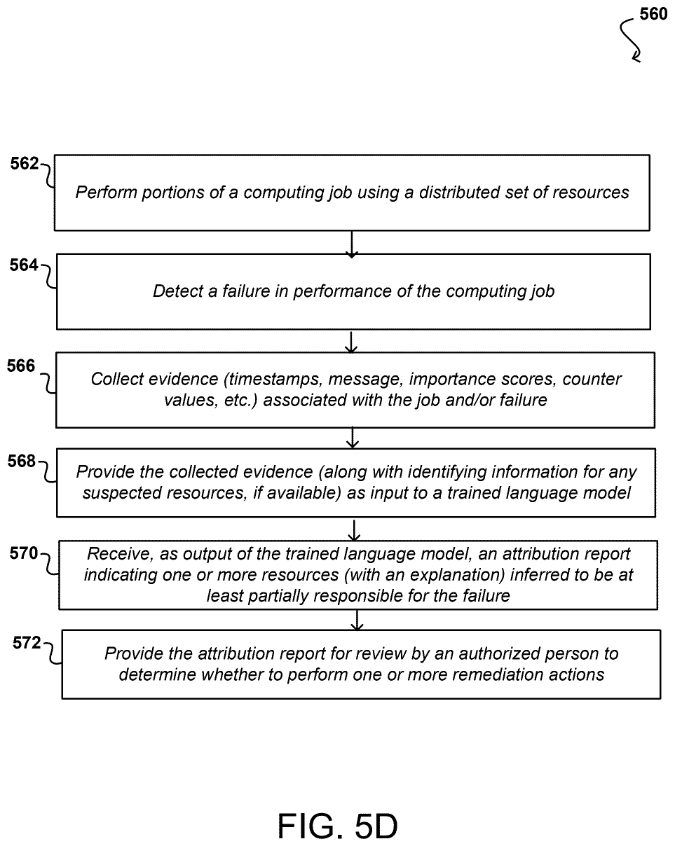

FIG. 5A illustrates an example process 500 that can be performed to determine the source(s) of a failure in a compute job in accordance with at least one embodiment. It should be understood that for this and other processes discussed herein that there may be additional, fewer, or alternative steps performed in similar or alternative orders, or at least partially in parallel, within the scope of the various embodiments. Further, although discussed with respect to failure of a compute job, it should be understood that advantages of node attribution can be beneficial for other types of events or occurrences as well within the scope of various embodiments. In this example process, portions of a computing job are performed 502 using a distributed set of resources, where individual resources may be allocated for performance of one or more respective portion of the computing job. During or after completion of performance, a failure in the computing job can be detected 504. This detection may occur in response to monitoring information in a job queue, among other such options. Two or more types of data can be collected and analyzed to attempt to determine one or more of the resources that were likely causes of the failure. This may include for example, text and time-series data generated with respect to the performance. In this example, a statistical analysis of a collection of text entries (e.g., log messages) can be performed 508 to identify a first subset of the resources that are potentially associated with the failure. Anomaly detection can also be performed 510 with respect to a collection of time series data (e.g., telemetry data) to identify a second subset of resources potentially associated with the failure. In some embodiments the first and second subsets may at least partially overlap, or a given subset may be empty if an attribution score for all resources falls below a score threshold or otherwise fails to satisfy a selection criterion.

In this example, identifying information for the resources of the first and second subsets (along with any other identified potentially responsible resources) can be provided 512 as input to a trained language model. The information can be provided in a generated prompt, which can further include supporting evidence (e.g., relevant topologies or graphs) and other relevant information. In at least some embodiments, filtering and summarization can be performed before generating the prompt in order to provide for more accurate inferencing. The language model can be trained to filter out, or ignore, certain types of information that are known to be unrelated to at least a certain type of job failure. The language model can also be trained to apply relative weights or importance scores to certain types of evidence, in order to generate more accurate attribution determinations. An attribution report can be generated and received 514 as output of the trained language model, indicating one or more resources that are inferred to be at least partially responsible for the failure of the computing job. The attribution report can contain other information as well, such as evidence for the attribution, an explanation for the attribution decision, and one or more suggested actions or remediations, among other such options. The attribution report can be provided 516 for review by an authorized person, such as through a job dashboard, allowing the person to determine whether to perform one or more remediation actions, which may correspond to, or differ from, any recommended actions in the attribution report. In some embodiments, at least some types of remediation actions may be able to be performed automatically, as discussed in more detail elsewhere herein.

FIG. 5B illustrates another example process 520 that can be performed to determine the source of a failure (or other identified issue) in execution of a compute job, in accordance with at least one embodiment. In this example process, portions of a computing job are performed 522 using a distributed set of resources, where individual resources may be allocated for performance of one or more respective portion of the computing job. During or after completion of performance, a failure (or other such issue) in the computing job can be detected 524, as discussed above. A set of text data, as may include log entries (e.g., application, event, or system logs), job reports, or any other collection of text data related to performance of a job, can be collected that may be associated with performance of the job. In this example, a statistical analysis of the collection of text entries is performed 526 to identify a subset of the resources that are potentially associated with the failure. As mentioned, a text entry can be used to identify a potentially responsible node if its importance, as reflected by importance values such as TF-IDF values, exceeds the average importance of this text entry across the population of nodes. In this example, identifying information for the identified resources can be provided 528 as input to a trained language model. The information can be provided via a generated prompt, for example, which may further include supporting evidence and other relevant information. An attribution report can be received 530 as output of the trained language model, indicating one or more resources that are inferred to be at least partially responsible for the failure of the computing job. The attribution report can contain other information as well, such as evidence for the attribution, an explanation for the attribution decision, confidence scores for the evidence, and one or more suggested actions or remediations, among other such options.

FIG. 5C illustrates another example process 540 that can be performed to determine the source of a failure (or other identified issue) in a compute job, in accordance with at least one embodiment. In this example process, portions of a computing job are performed 542 using a distributed set of resources, where individual resources may be allocated for performance of one or more respective portion of the computing job. During or after completion of performance, a failure (or other such issue) in the computing job can be detected 544, as discussed above. There may be one or more streams of time series (e.g., telemetry data) that are associated with the job. In this example, anomaly detection can be performed 546 with respect to a collection of time series data (e.g., telemetry data) to identify resources potentially associated with the failure. As mentioned, this may include identifying any deviations from an expected value, or range of values, for one or more types of data that may be indicative of, or at least associated with, a cause of a job failure. In at least one embodiment, an attempt can be made to identify events signified by specific counters, such as counters that are related to error rates or likely to be related to failures. There may be counters that are associated with the networking part of a cluster or data center, as may be related to switches and networking components. There may also be different layers within this network that may have respective counters. An unexpected variation in counter value or frequency may be an indicator of a potential issue with one of these associated nodes.

Identifying information for the identified resources can be provided 548 as input to a trained machine learning model, such as a large language model. The information can be provided via a generated prompt, for example, which may further include supporting evidence and other relevant information. An attribution report can be received 550 as output of the trained language model, indicating one or more resources that are inferred to be at least partially responsible for the failure of the computing job. The attribution report can contain other information as well, such as evidence for the attribution, an explanation for the attribution decision, and one or more suggested actions or remediations, among other such options.

FIG. 5D illustrates another example process 560 that can be performed to determine the source of a failure (or other identified issue) in a compute job, in accordance with at least one embodiment. In this example process, portions of a computing job are performed 562 using a distributed set of resources, where individual resources may be allocated for performance of one or more respective portion of the computing job. During or after completion of performance, a failure (or other such issue) in the computing job can be detected 564, as discussed above. A set of evidence can be collected 566 that may be associated with the job and/or failure. This may include evidence of various types from various sources, as may include timestamp data, text messages, importance scores, and/or counter values, among other such options. In at least some embodiments, the evidence may be processed to remove redundant or unimportant evidence data, select potentially important evidence data to include, or reformat evidence data, among other processing or filtering options. The collected (and potentially processed) evidence data can be provided 568, along with identifying information for any suspected resources, if available, as input to a trained machine learning model, such as a large language model. The information can be provided via a generated prompt, for example, which may further include other relevant information. An attribution report can be received 570 as output of the trained language model, indicating one or more resources that are inferred to be at least partially responsible for the failure of the computing job. The attribution report can contain other information as well, such as evidence for the attribution, an explanation for the attribution decision, and one or more suggested actions or remediations, among other such options. The attribution report can then be provided 572 for review by an authorized person to determine whether to perform any of the suggested, or other, remediation actions.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server 620 or third party service 660, among other such options. In some instances, at least a portion of the processing, generation, compositing, and/or determination of this content may be performed by one of these other devices, systems, or entities, then provided to the client device (or another such recipient) for presentation or another such use.

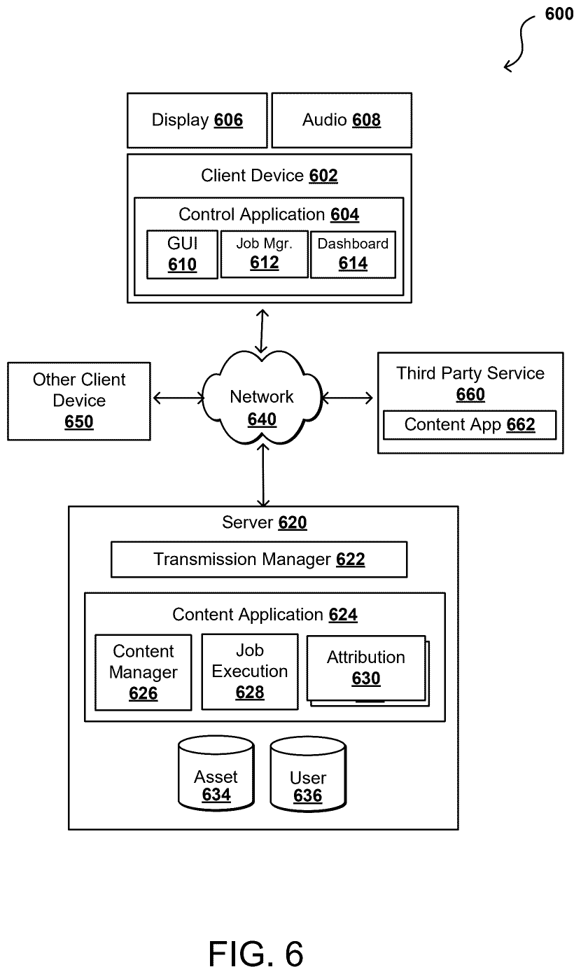

As an example, FIG. 6 illustrates an example network configuration 600 that can be used to provide, generate, modify, encode, process, and/or transmit data or other such content as part of the performance of a computing job. In at least one embodiment, a client device 602 can generate or receive data for a session using components of a content application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content from an asset repository 634 (or other such location) to be determined by a content manager 626. A content manager 626 may work with a job execution module 628 to perform one or more computing tasks or operations. In at least one embodiment, the content application 624 can work with one or more attribution modules 630 to attempt to determine a cause of any fault in a computing job, or other such event. At least a portion of the results of the job or findings of attribution may be transmitted to the client device 602 using an appropriate transmission manager 622 to send by download, streaming, or another such transmission channel. In at least one embodiment, the client device 602 receiving such data can provide this data (or related content, etc.) to a corresponding content application 604, which may also or alternatively include a graphical user interface 610, job manager 612, and dashboard 614 for use in providing, synthesizing, rendering, compositing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

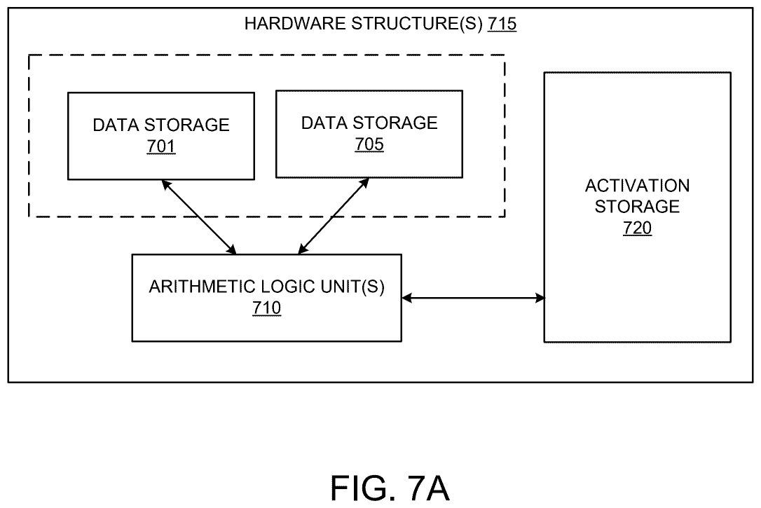

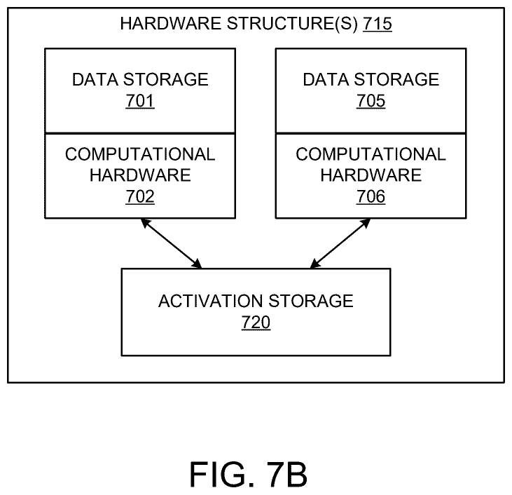

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

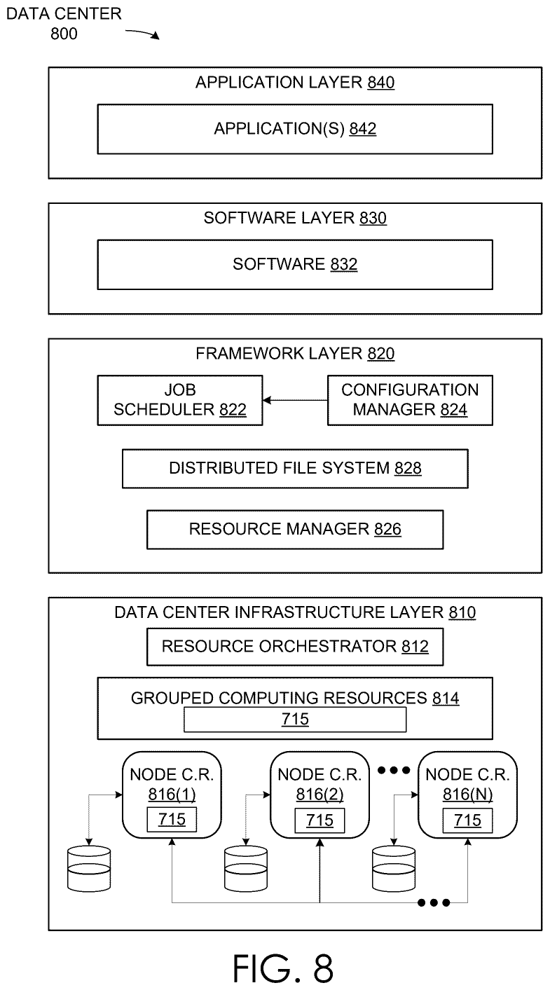

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to attribute blame to one or more nodes of a distributed system responsible for failure of a computing job.

### Computer Systems

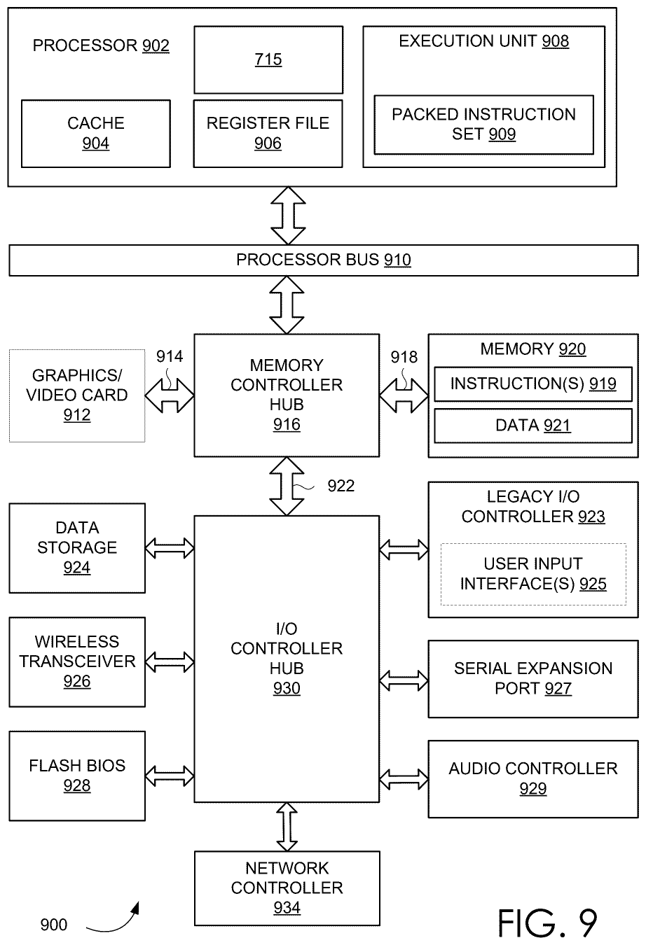

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to attribute blame to one or more nodes of a distributed system responsible for failure of a computing job.

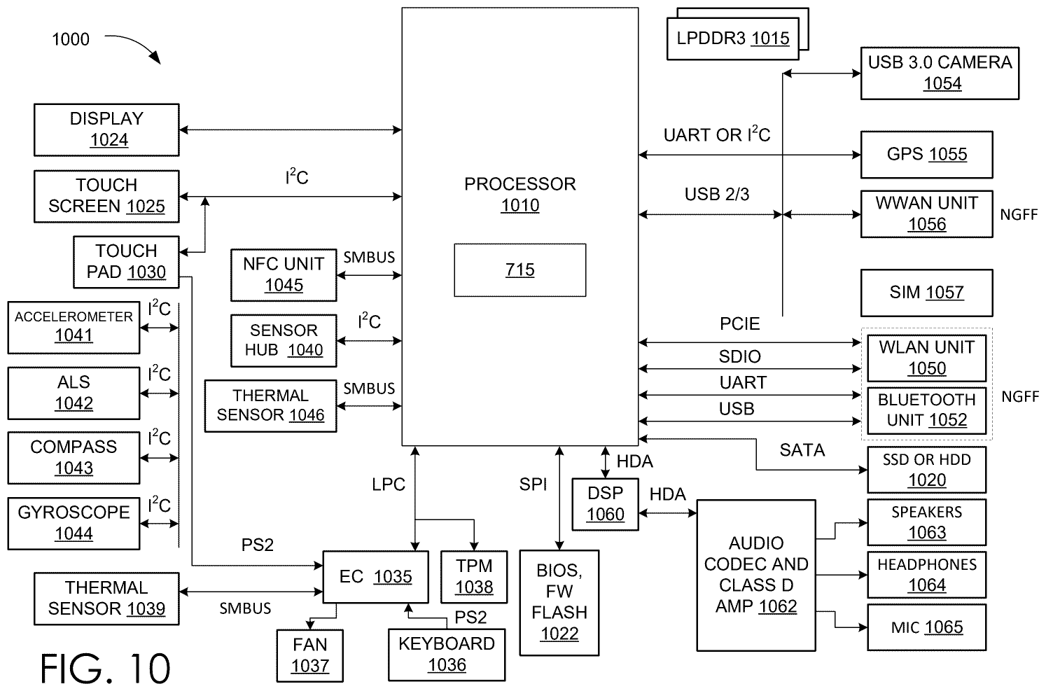

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to attribute blame to one or more nodes of a distributed system responsible for failure of a computing job.

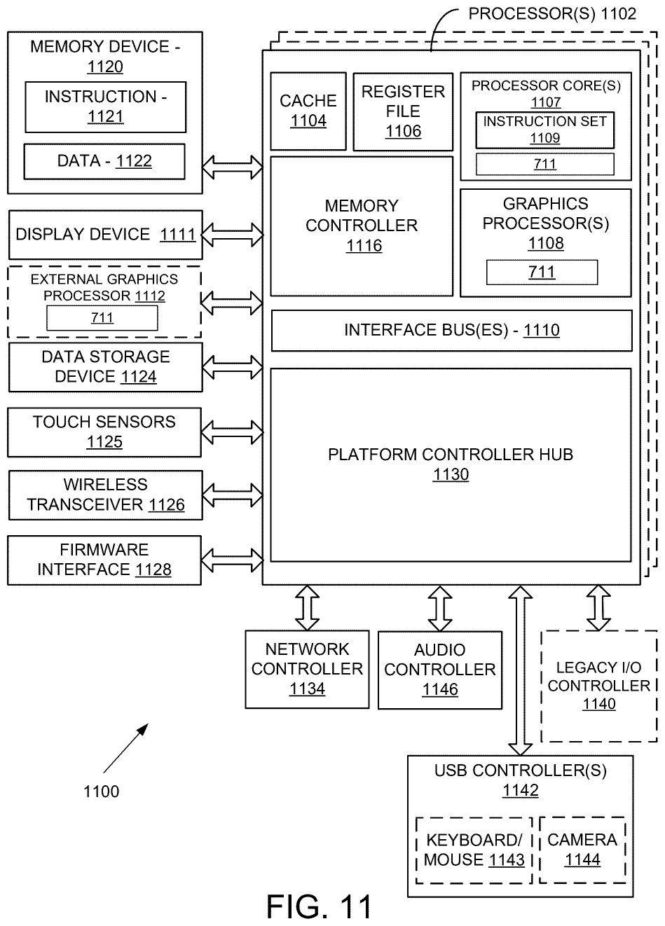

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to attribute blame to one or more nodes of a distributed system responsible for failure of a computing job.

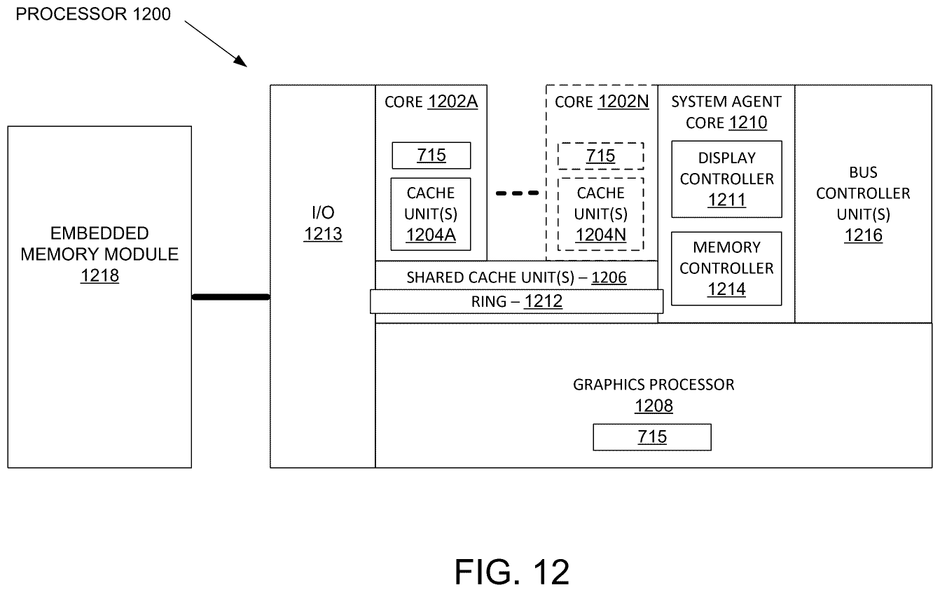

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to attribute blame to one or more nodes of a distributed system responsible for failure of a computing job.

### Virtualized Computing Platform

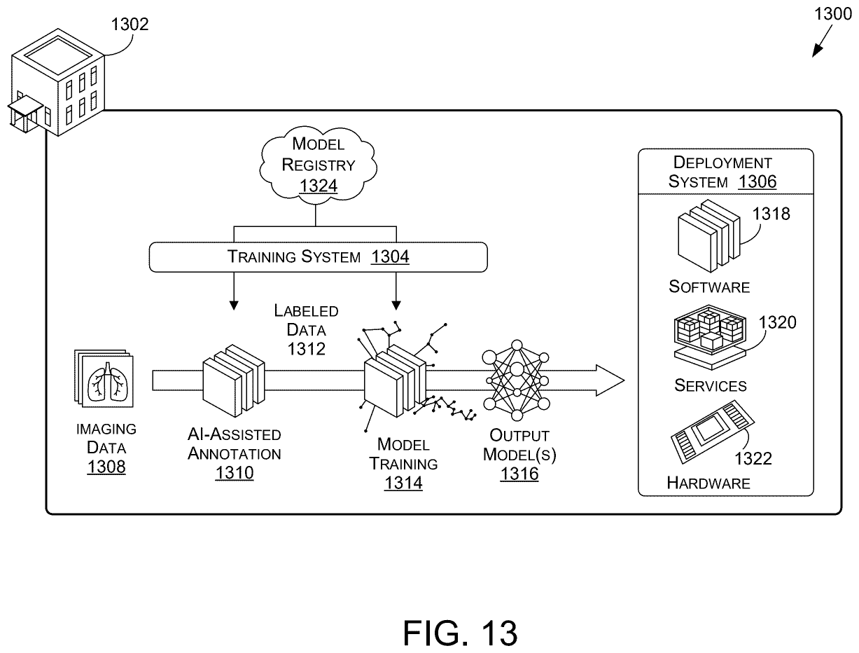

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

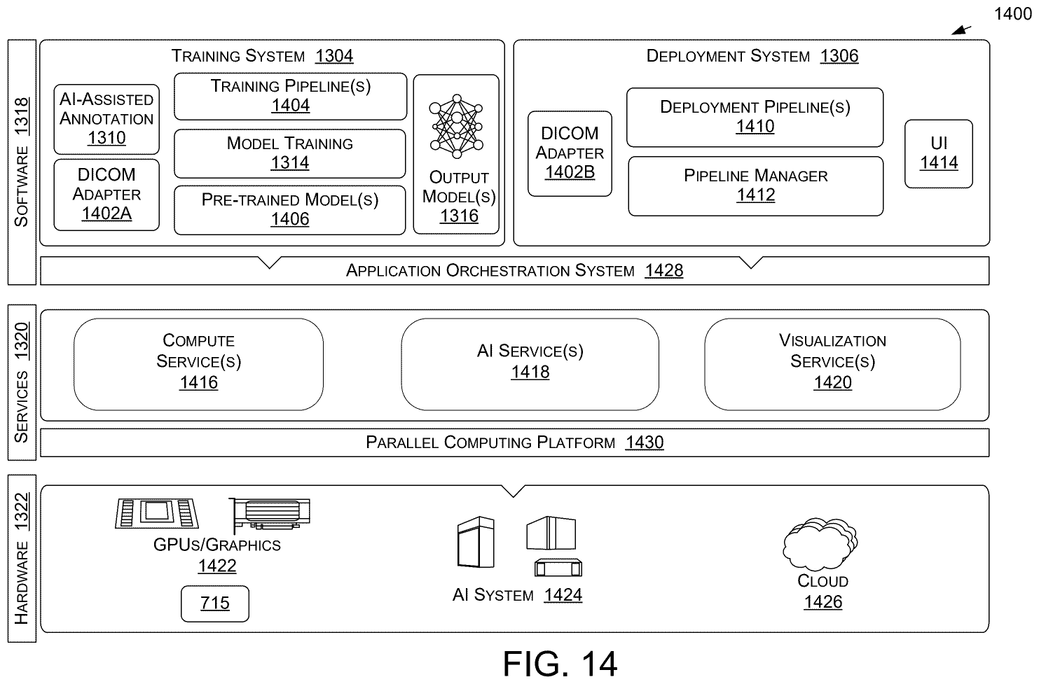

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

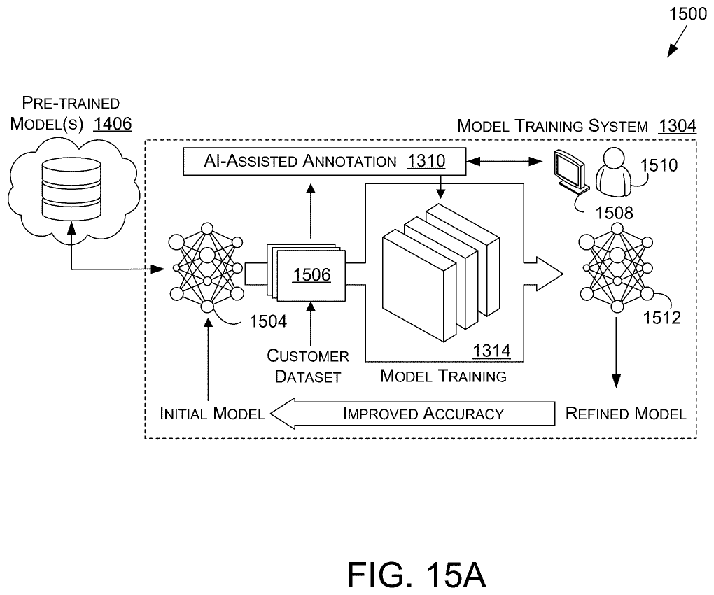

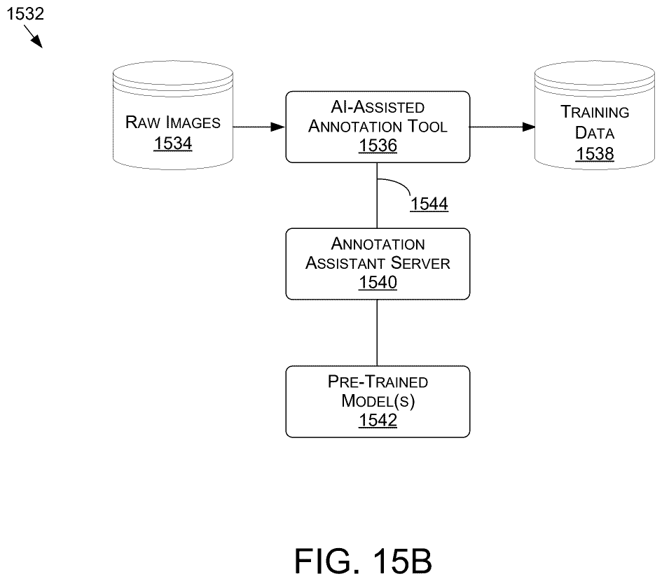

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A system, comprising:
one or more processors to:
   detect a failure in a job performed using a plurality of resources;
   perform a statistical analysis of a collection of text entries, obtained from two or more sources, to identify a subset of the resources potentially associated with the failure;
   provide identifying information for the subset as input to a trained language model; and
   receive, as output of the trained language model, an attribution report indicating one or more resources inferred to be at least partially responsible for the failure, along with an explanation for selection of the one or more resources.
2. The system of clause 1, wherein the statistical analysis includes generation of one or more importance matrices using term frequency-inverse document frequency (TF-IDF) values of the text entries.
3. The system of clause 2, wherein the importance of a respective text entry is compared against an average importance across the plurality of resources, identified as a set of nodes associated with respective importance values, to identify anomalous text messages associated with specific resources.
4. The system of clause 2, wherein a first subset of log entry data is used to generate a reference importance matrix and a remaining subset of the log entry data is used to generate an attribution importance matrix to be compared against the reference importance matrix.
5. The system of clause 1, wherein the two or more sources include one or more of networking sources, compute sources, or storage sources associated with the plurality of resources.
6. The system of clause 1, wherein the one or more processors are further to:
perform anomaly detection with respect to a collection of time series data, obtained from the two or more sources, to identify a second subset of the resources potentially associated with the failure; and
provide identifying information for the second subset as additional input to the trained language model.
7. The system of clause 1, wherein the one or more processors are further to:
provide supporting evidence as additional input to the trained language model, the supporting evidence including at least one of content of a message, a timestamp, an importance score, or a counter value.
8. The system of clause 7, wherein the supporting evidence includes at least one of timestamp, message, importance score, or counter value data.
9. The system of clause 1, wherein the attribution report further includes one or more suggested actions to be performed in response to the failure, based in part on the one or more resources determined to be at least partially responsible for the failure.
10. The system of clause 1, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.
11. A system, comprising:
one or more processors to:
   detect a failure in a job performed using a plurality of resources;
   perform anomaly detection with respect to a collection of time series data, obtained from two or more sources, to identify a subset of the resources potentially associated with the failure;
   provide identifying information for the subset as input to a trained language model; and
   receive, as output of the trained language model, an attribution report indicating one or more resources inferred to be at least partially responsible for the failure, along with an explanation for selection of the one or more resources.
12. The system of clause 11, wherein the time series data includes telemetry data for the plurality of resources and counter values associated with the telemetry data.
13. The system of clause 11, wherein the one or more processors are further to:
perform a statistical analysis of a collection of text entries, obtained from two or more sources, to identify a second subset of the resources potentially associated with the failure; and
provide identifying information for the second subset as additional input to the trained language model.
14. The system of clause 13, wherein the statistical analysis includes generation of one or more importance matrices using term frequency-inverse document frequency (TF-IDF) values of the text entries.
15. The system of clause 13, wherein an importance of a respective text entry is compared against an average importance across the plurality of resources, identified as a set of nodes associated with respective importance values, to identify anomalous text messages associated with specific resources.
16. The system of clause 11, wherein the one or more processors are further to:
provide supporting evidence as additional input to the trained language model, the supporting evidence including at least one of content of a message, a timestamp, an importance score, or a counter value.
17. At least one processor, comprising:
one or more logical units to:
   detect a failure in a job performed using a plurality of resources;
   provide, as input to a trained language model, identifying information for a subset of the resources determined to be potentially associated with the failure, along with supporting evidence for the subset; and
   receive, as output of the trained language model, indication of one or more resources inferred to be at least partially responsible for the failure, along with an explanation for selection of the one or more resources.
18. The at least one processor of clause 17, wherein the supporting evidence includes at least one of content of a message, a timestamp, an importance score, or a counter value related to the job.
19. The at least one processor of clause 17, wherein the one or more logical units are further to:
perform a statistical analysis of a collection of text entries, obtained from two or more sources, to identify one or more of the resources potentially associated with the failure.
20. The at least one processor of clause 17, wherein the one or more logical units are further to:
perform anomaly detection with respect to a collection of time series data, obtained from two or more sources, to identify one or more of the resources potentially associated with the failure.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processors to:
detect a failure in a job performed using a plurality of resources;
perform a statistical analysis of a collection of text entries, obtained from two or more sources, to identify a subset of the resources potentially associated with the failure;
provide identifying information for the subset as input to a trained language model; and
receive, as output of the trained language model, an attribution report indicating one or more resources inferred to be at least partially responsible for the failure, along with an explanation for selection of the one or more resources.

2. The system of claim 1, wherein the statistical analysis includes generation of one or more importance matrices using term frequency-inverse document frequency (TF-IDF) values of the text entries.

3. The system of claim 2, wherein the importance of a respective text entry is compared against an average importance across the plurality of resources, identified as a set of nodes associated with respective importance values, to identify anomalous text messages associated with specific resources.

4. The system of claim 2, wherein a first subset of log entry data is used to generate a reference importance matrix and a remaining subset of the log entry data is used to generate an attribution importance matrix to be compared against the reference importance matrix.

5. The system of claim 1, wherein the two or more sources include one or more of networking sources, compute sources, or storage sources associated with the plurality of resources.

6. The system of claim 1, wherein the one or more processors are further to:
perform anomaly detection with respect to a collection of time series data, obtained from the two or more sources, to identify a second subset of the resources potentially associated with the failure; and
provide identifying information for the second subset as additional input to the trained language model.

7. The system of claim 1, wherein the one or more processors are further to:
provide supporting evidence as additional input to the trained language model, the supporting evidence including at least one of content of a message, a timestamp, an importance score, or a counter value.

8. The system of claim 7, wherein the supporting evidence includes at least one of timestamp, message, importance score, or counter value data.

9. The system of claim 1, wherein the attribution report further includes one or more suggested actions to be performed in response to the failure, based in part on the one or more resources determined to be at least partially responsible for the failure.

10. The system of claim 1, wherein the system is at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for performing generative operations using a language model (LM);
a system for synthetic data generation;
a collaborative content creation platform for 3D assets; or
a system implemented at least partially using cloud computing resources.

11. A system, comprising:
one or more processors to:
detect a failure in a job performed using a plurality of resources;
perform anomaly detection with respect to a collection of time series data, obtained from two or more sources, to identify a subset of the resources potentially associated with the failure;
provide identifying information for the subset as input to a trained language model; and
receive, as output of the trained language model, an attribution report indicating one or more resources inferred to be at least partially responsible for the failure, along with an explanation for selection of the one or more resources.

12. The system of claim 11, wherein the time series data includes telemetry data for the plurality of resources and counter values associated with the telemetry data.

13. The system of claim 11, wherein the one or more processors are further to:
perform a statistical analysis of a collection of text entries, obtained from two or more sources, to identify a second subset of the resources potentially associated with the failure; and
provide identifying information for the second subset as additional input to the trained language model.

14. The system of claim 13, wherein the statistical analysis includes generation of one or more importance matrices using term frequency-inverse document frequency (TF-IDF) values of the text entries.

15. The system of claim 13, wherein an importance of a respective text entry is compared against an average importance across the plurality of resources, identified as a set of nodes associated with respective importance values, to identify anomalous text messages associated with specific resources.

16. The system of claim 11, wherein the one or more processors are further to:
provide supporting evidence as additional input to the trained language model, the supporting evidence including at least one of content of a message, a timestamp, an importance score, or a counter value.

17. At least one processor, comprising:
one or more logical units to:
detect a failure in a job performed using a plurality of resources;
provide, as input to a trained language model, identifying information for a subset of the resources determined to be potentially associated with the failure, along with supporting evidence for the subset; and
receive, as output of the trained language model, indication of one or more resources inferred to be at least partially responsible for the failure, along with an explanation for selection of the one or more resources.

18. The at least one processor of claim 17, wherein the supporting evidence includes at least one of content of a message, a timestamp, an importance score, or a counter value related to the job.

19. The at least one processor of claim 17, wherein the one or more logical units are further to:
perform a statistical analysis of a collection of text entries, obtained from two or more sources, to identify one or more of the resources potentially associated with the failure.

20. The at least one processor of claim 17, wherein the one or more logical units are further to:
perform anomaly detection with respect to a collection of time series data, obtained from two or more sources, to identify one or more of the resources potentially associated with the failure.
